(19) United States
(12) Patent Application Publication
(10) Pub. No.: US 2026/0172801 A1
(43) Pub. Date: Jun. 18, 2026

(54) ELECTRONIC DEVICE AND METHOD FOR WIRELESS COMMUNICATION, AND COMPUTER-READABLE STORAGE MEDIUM

(71) Applicant: Sony Group Corporation, Tokyo (JP)

(72) Inventors: Tao CUI, Beijing (CN); Chen SUN, Beijing (CN)

(73) Assignee: Sony Group Corporation, Tokyo (JP)

(21) Appl. No.: 19/129,673

(22) PCT Filed: Nov. 17, 2023
(86) PCT No.: PCT/CN2023/132291

§ 371 Date: May 14, 2025

(30) Foreign Application Priority Data
Nov. 25, 2022 (CN) 202211488978.8

(51) Int. Cl. H04W 8/00; H04W 48/16; H04W 72/0446; H04W 72/21; H04W 76/14; H04W 88/06

(52) U.S. Cl. CPC H04W 8/005; H04W 48/16; H04W 72/0446; H04W 72/21; H04W 76/14; H04W 88/06

(57) ABSTRACT

Provided in the present disclosure are an electronic device and method for wireless communication, and a computer-readable storage medium. The electronic device comprises: a processing circuit, which is configured to determine, at least on the basis of the processing capabilities of wireless communication terminals within the coverage range of a wireless transceiving node and a wireless communication environment, wireless communication terminals which are about to participate in federated reinforcement learning; and acquire respective local learning models from wireless communication terminals which participate in federated reinforcement learning, and obtain an updated global model on the basis of the local learning models.

The present application claims priority to Chinese Patent Application No.202211488978.8, titled “ELECTRONIC DEVICE AND METHOD FOR WIRELESS COMMUNICATION, AND COMPUTER-READABLE STORAGE MEDIUM”, filed on Nov. 25, 2022 with the China National Intellectual Property Administration, which is incorporated herein by reference in its entirety.

### FIELD

The present disclosure relates to the technical field of wireless communications, specifically to updating of a global model based on Federated Reinforcement Learning. More specifically, the present disclosure relates to an electronic apparatus and a method for wireless communications, and a computer-readable storage medium.

### BACKGROUND

As machine learning develops, it becomes more capable of solving complex problems such as image processing, language recognition and semantic understanding.

From a technical perspective, Federated Learning (FL) is a distributed federated learning solution, in which respective local models trained by multiple users are utilized to jointly build a shared model while maintaining privacy of user data. FIG. 1 shows an example of a model of FL. Participants perform training based on their own dataset to obtain local models, such as local models A to C, and submit the local models to a coordinator. The coordinator aggregates the local models to obtain a global model. The coordinator further provides the updated global model to the participants.

Reinforcement Learning (RL) is a branch of machine learning that focuses on how individual users interact with an environment and maximizes a cumulative reward. The process of reinforcement learning allows the individuals to learn through fault-tolerant attempts and improve their behaviors. The individuals participating in the RF take actions to explore the environment and expect to be rewarded accordingly, through a series of strategies.

FIG. 2 shows an example of a model of reinforcement learning. An agent which is an individual user takes an action Aₜ based on the environment at state Sₜ and obtains a reward Rₜ₊₁ at the next state Sₜ₊₁. For reinforcement learning, an important problem is to avoid leakage of user information, so as to protect privacy of the user to the greatest extent. This is because raw data transmission between an individual and a central processor has great security risks.

In this case, federated learning is advantageous, because it can not only implement information interaction without leaking user privacy information, but also help users adapt to different environments. Another problem about reinforcement learning is that multiple algorithms require pre-training models in a simulation environment, but the simulation environment cannot fully reflect and replicate a real environment. Federated learning can bring together a simulation environment and a real environment and thereby build a bridge between the simulation environment and the real environment.

In view of the above, the concept of Federated Reinforcement Learning (FRL) is proposed. In other words, the FRL may be regarded as a combination of federated learning and reinforcement learning under data privacy protection. Some of parameters of reinforcement learning may be presented in federated learning and used to handle continuous decision-making tasks.

### SUMMARY

A brief summary of the present disclosure is given below to provide basic understanding on some aspects of the present disclosure. It should be understood that the summary is not an exhaustive summary of the present disclosure. It is not intended to identify the key or important parts of the present disclosure, nor is it intended to limit the scope of the present disclosure. Its purpose is merely to present concepts in a simplified form, which serves as a preamble of a more detailed description to be discussed later.

In an aspect according to the present disclosure, an electronic apparatus for wireless communications is provided, including processing circuitry. The processing circuitry is configured to: determine, at least based on a wireless communication environment and processing capabilities of wireless communication terminals within a coverage range of a wireless transceiving node, wireless communication terminals which are to participate in Federated Reinforcement Learning (FRL); and acquire, from the wireless communication terminals participating in the FRL, respective local learning models, and obtain an updated global model based on the local learning models.

In another aspect according to the present disclosure, a method for wireless communications is provided. The method includes: determining, at least based on a wireless communication environment and processing capabilities of wireless communication terminals within a coverage range of a wireless transceiving node, wireless communication terminals which are to participate in Federated Reinforcement Learning (FRL); and acquiring, from the wireless communication terminals participating in the FRL, respective local learning models, and obtaining an updated global model based on the local learning models.

In an aspect according to the present disclosure, an electronic apparatus for wireless communications is provided, including processing circuitry. The processing circuitry is configured to: in response to confirmation information from a wireless transceiving node, perform training of a local learning model at a wireless communication terminal, wherein the confirmation information indicates that the wireless transceiving node determines, based on a wireless communication environment and a processing capability of the wireless communication terminal, that the wireless communication terminal is to participate in FRL; and upload the local learning models to the wireless transceiving node and acquire an updated global model from the wireless transceiving node.

In another aspect according to the present disclosure, a method for wireless communications is provided. The method includes: in response to confirmation information from a wireless transceiving node, performing training of a local learning model at a wireless communication terminal, wherein the confirmation information indicates that the wireless transceiving node determines, based on a wireless communication environment and a processing capability of the wireless communication terminal, that the wireless communication terminal is to participate in FRL; and uploading the local learning model to the wireless transceiving node and acquiring an updated global model from the wireless transceiving node.

In another embodiment according to the present disclosure, computer program codes and a computer program product for implementing the above methods for wireless communications are further provided, and a computer-readable storage medium recording the computer program codes for implementing the methods for wireless communications is provided.

With the electronic apparatus and method according to the embodiments of the present disclosure, the wireless communication terminal to participate in the FRL is selectively determined, so that a probability of congestion in data transmission is reduced, a transmission latency is reduced, and performance of learning is ensured.

These and other advantages of the present disclosure will be more apparent from the following detailed description of preferred embodiments of the present disclosure in conjunction with the accompanying drawings.

### BRIEF DESCRIPTION OF THE DRAWINGS

To further set forth the above and other advantages and features of the present disclosure, detailed descriptions are made for implementations of the present disclosure in the following in conjunction with accompanying drawings. The drawings, together with the detailed description below, are incorporated into and form a part of the specification. Elements having the same function and structure are denoted by the same reference numerals. It should be understood that the accompanying drawings only illustrate typical embodiments of the present disclosure and should not be construed as a limitation to the scope of the present disclosure. In the accompanying drawings:

FIG. 1 shows an example of a model of Federated Learning;

FIG. 2 shows an example of a model of Reinforcement Learning;

FIG. 3 is a block diagram showing functional modules of an electronic apparatus for wireless communications according to an embodiment of the present disclosure;

FIG. 4 shows an example of relevant information flow of an FRL process;

FIG. 5 shows another example of relevant information flow of an FRL process;

FIG. 6 shows an example of relevant information flow of assisted module upload in FRL;

FIG. 7 is a block diagram showing functional modules of an electronic apparatus for wireless communications according to another embodiment of the present disclosure;

FIG. 8 shows another example of relevant information flow of assisted module upload in FRL;

FIG. 9 shows a schematic diagram of a reward function design;

FIG. 10 shows an example of relevant information flow of FRL in a platoon application scenario;

FIG. 11 shows a flowchart of a method for wireless communications according to an embodiment of the present disclosure;

FIG. 12 shows a flowchart of a method for wireless communications according to another embodiment of the present disclosure;

FIG. 13 is a block diagram showing a first example of a schematic configuration of an eNB or gNB to which the technology of the present disclosure may be applied;

FIG. 14 is a block diagram showing a second example of a schematic configuration of an eNB or gNB to which the technology of the present disclosure may be applied;

FIG. 15 is a block diagram showing an example of a schematic configuration of a smartphone to which the technology of the present disclosure may be applied;

FIG. 16 is a block diagram showing an example of a schematic configuration of a vehicle navigation apparatus to which the technology according to the present disclosure may be applied; and

FIG. 17 is a block diagram of an exemplary structure of a general-purpose personal computer capable of implementing a method and/or device and/or system according to embodiments of the present disclosure.

### DETAILED DESCRIPTION

An exemplary embodiment of the present disclosure will be described hereinafter in conjunction with the accompanying drawings. For the sake of clarity and conciseness, not all the features of practical implementations are described in the specification. However, it should be understood that during a process of developing any such embodiment, many decisions specific to the embodiments have to be made, to achieve a specific target of a developer, for example, conforming to limitation conditions related to a system and a service. The limitation conditions may change for different embodiments. Furthermore, it should further be understood that although the development work may be very complicated and time-consuming, for those skilled in the art benefiting from the present disclosure, such development work is only a routine task.

Herein, it should be further noted that in order to avoid obscuring the present disclosure due to unnecessary details, only apparatus structures and/or processing steps closely related to the solutions according to the present disclosure are illustrated in the drawings, and other details less related to the present disclosure are omitted.

### First Embodiment

As mentioned above, FRL may be used to perform training of a global model in a network environment. In this case, users of FRL need to exchange a large number of model parameters, intermediate results and the like with other users and/or network-side servers, consuming quantities of communication resources and electric power. Therefore, communication resource overhead and battery capacity limitation of user-side apparatuses need to be considered. For example, model upload and download strategies need to be coordinated to maximize an iteration efficiency of model update. Specifically, for example, the number of model interactions may be optimized by using a model dynamic update mechanism. The volume of interaction data may be reduced by using a model compression algorithm, and the model aggregation algorithm may be optimized to allow a user participating in the FRL to upload only important parameters of a local learning model and the like.

In this embodiment, a technical solution is provided, in which the iteration efficiency of model update is improved by optimizing selection of users participating in FRL, or optimizing a coordination manner of model upload among users.

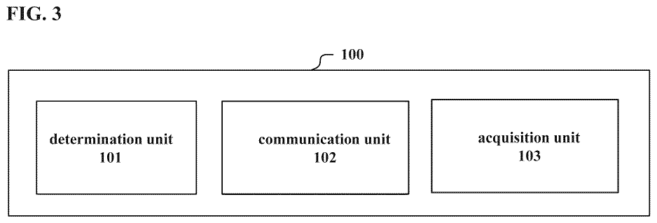

FIG. 3 is a block diagram showing functional modules of an electronic apparatus 100 for wireless communications according to an embodiment of the present disclosure. As shown in FIG. 3, the electronic apparatus 100 includes a determination unit 101, a communication unit 102 and an acquisition unit 103. The determination unit 101 is configured to determine, at least based on processing capabilities and a wireless communication environment of wireless communication terminals within a coverage range of a wireless transceiving node, wireless communication terminals which are to participate in Federated Reinforcement Learning (FRL). The communication unit 102 is configured to acquire, from the wireless communication terminals participating in the FRL, respective local learning models. The acquisition unit 103 is configured to obtain an updated global model based on the local learning models.

The electronic apparatus 100 may be arranged at the network side or on the cloud server side, for example, at the wireless transceiving node side. The wireless transceiving node may be a base station, an access point (AP), a road side unit, and the like. In addition, the wireless communication terminals here may be various user equipments (UEs) or user terminals capable of participating in the FRL, or may be communication terminals such as mobile base stations.

The determination unit 101, the communication unit 102 and the acquisition unit 103 may be implemented by one or more processing circuitries. Such processing circuitry may be, for example, implemented as a chip or a processor. Moreover, it should be understood that the functional units in the electronic apparatus shown in FIG. 3 are only logical modules defined based on specific functions thereof, and are not intended to limit a specific implementation.

It should further be noted that the electronic apparatus 100 may be implemented at a chip level, or may be implemented at an apparatus level. For example, the electronic apparatus 100 may operate as the wireless transceiving node and may further include external apparatuses such as a memory and a transceiver (not shown in the figure). The memory may be configured to store related data information and programs to be executed by the wireless transceiving node to implement various functions. The transceiver may include one or more communication interfaces to support communications with different apparatuses (such as other wireless transceiving nodes and UEs). An implementation of the transceiver is not specifically limited here.

Theoretically, more wireless communication terminals participating in FRL leads to better performance of learning. This is because increasing of samples of a dataset enhances a degree to which a system model cognizes a learning object. The wireless communication terminals need to upload model parameters after local learning, causing occupation of wireless resources. As more wireless communication terminals participate in the FRL, more uplink transmission resources are occupied simultaneously, which is prone to generate a network storm of data upload, resulting in congestion in data transmission and expansion of a transmission latency, thereby seriously affecting the effect of model aggregation and the timeliness of model distribution.

In this embodiment, the determination unit 101 selects the wireless communication terminals which are to participate in the FRL, in order to reduce the number of wireless communication terminals participating in the FRL while ensuring the learning performance. In an implementation, the determination unit 101 may consider the processing capabilities and the current wireless communication environment of the wireless communication terminals to select the most suitable wireless communication terminal for participating in the FRL.

For example, the wireless communication environment of the wireless communication terminal includes one or more of a wireless channel quality, a data rate, strength of interferences, a geographical location, an information transmission path loss related to the geographical location, and a movement speed. Preferably, the determination unit 101 may determine a wireless communication terminal with a better wireless communication environment to participate in the FRL to ensure transmission of the model parameters. Similarly, the determination unit 101 may preferably determine a wireless communication terminal with a stronger processing capability to participate in the FRL to ensure effective local model learning and model parameter uploading.

For example, when determining the learning terminals to participate in the FRL, the wireless communication environment of the wireless communication terminal has a higher weight than the processing capability of the wireless communication terminal. In other words, when the determination unit 101 cannot strike a balance between selecting a wireless communication terminal with a better wireless communication environment and selecting a wireless communication terminal with a stronger processing capability, the determination unit 101 preferably selects the wireless communication terminal with a better wireless communication environment to ensure that a latency of model update meets the requirements. It should be understood that this is not restrictive and may be modified according to an actual requirement.

The communication unit 102 may at least partially acquire information on the wireless communication environment and the processing capability from the wireless communication terminal. For example, the network side where the electronic apparatus 100 is located may for example acquire the movement speed by itself, and acquire the geographical location, the channel quality, the processing capability and the like from report of the wireless communication terminal. If the determination unit 101 is able to determine whether to select certain wireless communication terminals to participate in the FRL based on information on the network side, reporting of a channel state by these wireless communication terminals may be forbidden in a certain round to reduce signaling overhead.

In an exemplary scenario based on Internet of vehicles, the wireless communication terminal may be a vehicle or a vehicle in a platoon, and a learning object may be the environment where the vehicle is located, such as a traffic condition in the vicinity of the vehicle. The processing capability of the wireless communication terminal is, for example, one or more of an automated driving level of the vehicle and an environment perception capability of the vehicle. It should be noted that some descriptions below are made by taking the Internet of vehicles as a scenario example, which is not restrictive.

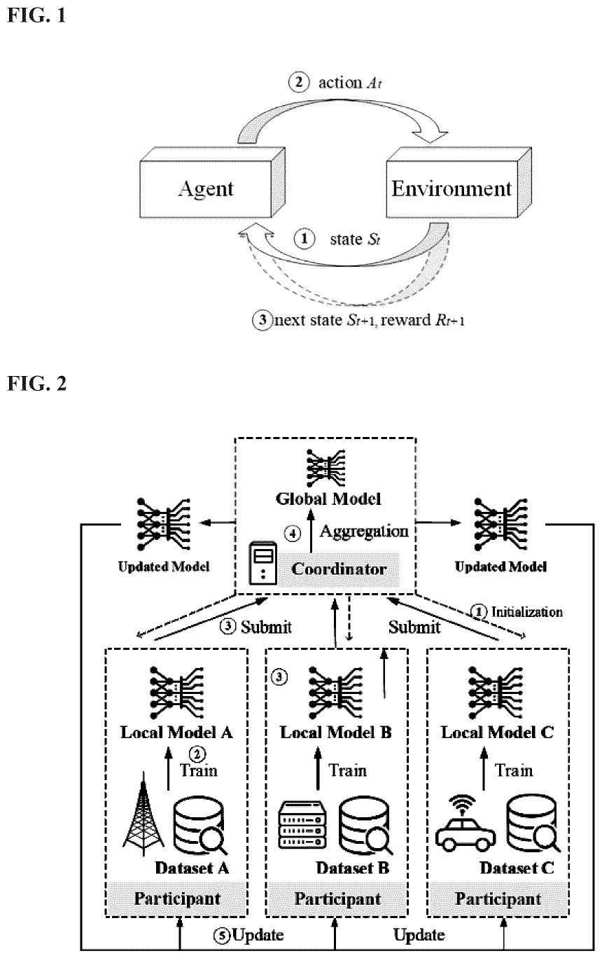

The wireless communication terminal participating in FRL train the local learning model based on a dataset stored thereon, and transmits the trained local learning model to the electronic apparatus 100 for model aggregation. It should be noted that the wireless communication terminal participating in the FRL initially receives an initial machine learning model distributed from the network side and performs initial training based on the initial machine learning model. The acquisition unit 103 for example aggregates local learning models acquired from respective wireless communication terminals to obtain an updated global model. For example, the acquisition unit 103 may perform the function of the coordinator shown in FIG. 1.

In the scenario of Internet of vehicles, in the training of the local learning model by a vehicle, a predetermined reward function may be defined. The reward function includes one or more of a forward driving reward, a collision avoidance reward and a speed maintenance reward. These reward functions are described in detail below.

In an example, the communication unit 102 is further configured to provide the updated global model to wireless communication terminals within the coverage of the wireless transceiving node. In this manner, all wireless communication terminals are aware of the latest update of the global model. Before the model converges, the number and identifications of determined wireless communication terminals participating in the FRL may be different in respective rounds of learning depending on changes in the wireless communication environment or other factors. In this example, even if a wireless communication terminal has not been selected to participate in the FRL for a long time period, the wireless communication terminal is provided with the latest updated global model. Therefore, the wireless communication terminal, when selected to participate in the FRL, is able to perform training based on the latest global model. In this way, positive feedback can be provided to the global model in the process of model aggregation, and thereby a convergence speed of the global model is improved.

For example, the communication unit 102 may provide a complete updated global model to the wireless communication terminals participating in the FRL, and provide a lightweight updated global model to the wireless communication terminal that does not participate in the FRL. The lightweight global model may be for example a global model with low complexity or low accuracy.

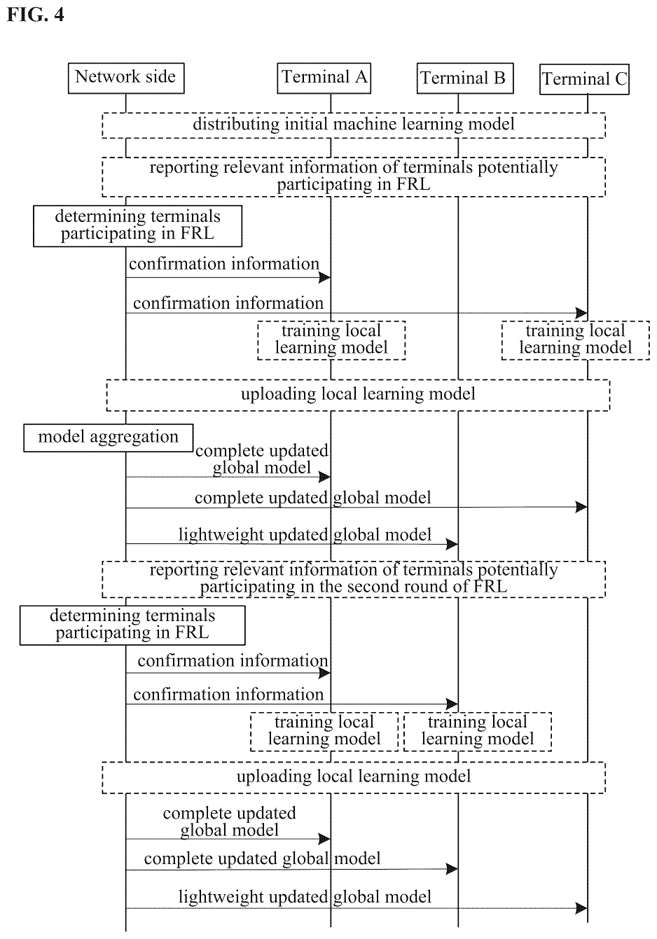

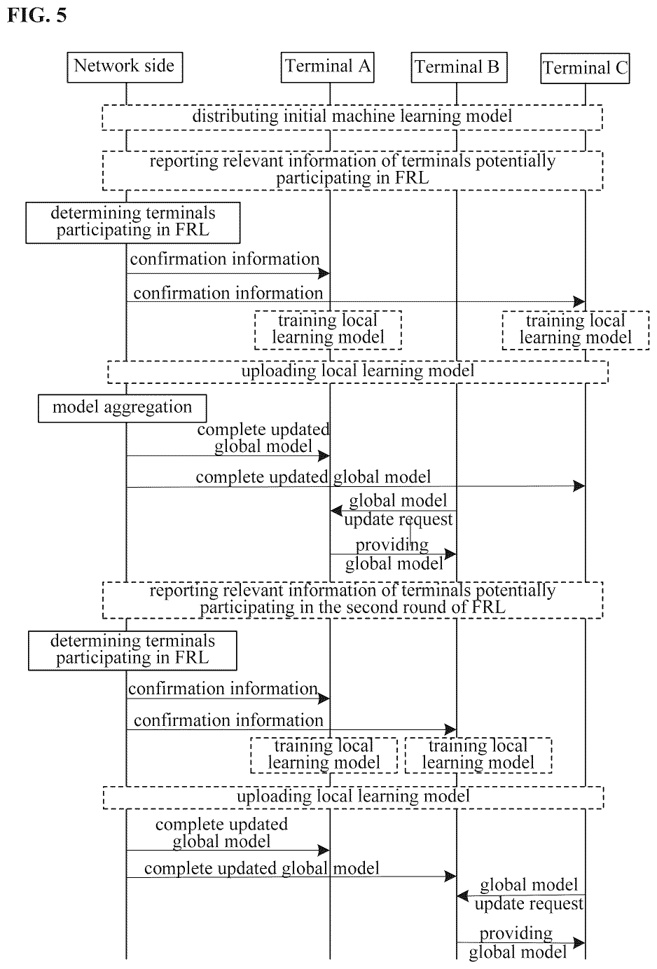

To facilitate understanding, FIG. 4 shows an example of relevant information flow of the FRL process. Here, a wireless communication terminal is abbreviated to terminal. The network side performs the functions of the electronic apparatus 100. It should be noted that in the information flow shown in FIG. 4 and other drawings, the number of terminals is exemplary and is not limited to 3 as shown.

Firstly, the network side distributes an initial machine learning model to terminals A to C as a basis for training. Then, a first round of FRL is started, and the terminals A to C which potentially participate in the FRL report relevant information of themselves to the network side. For example, the information is about a wireless communication environment and/or a processing capability. The network side determines terminals which are to participate in the FRL based on the received terminal-relevant information and/or information stored by itself. In the example of FIG. 4, terminal A and terminal C are determined to participate in the current round of FRL. Therefore, the network side informs terminal A and terminal C of confirmation information. On receipt of the confirmation information, terminal A and terminal C train local learning models respectively based on a local dataset and the initial machine learning model, and upload the local learning models to the network side. The network side aggregates the received local learning models to obtain an updated global model, transmits the obtained complete updated global model to terminal A and terminal C participating in the FRL, and transmits a lightweight updated global model to terminal B that does not participate in the FRL. In this way, all the terminals are enabled to maintain the latest version of the global model while ensuring fairness.

In a case that the model does not converge, a second round of FRL is performed. Similarly, terminals A to C which potentially participate in the FRL report their relevant information to the network side, for example, report information about a wireless communication environment and/or processing capabilities. It should be noted that if the network side is able to determine, without relevant information reported by terminal C, whether terminal C is to participate in the current round of FRL, information report by terminal C in the current round of FRL may be forbidden so as to reduce signaling overhead. The network side determines terminals to participate in the FRL based on the received terminal-relevant information and/or information stored by itself. In the example in FIG. 4, terminal A and terminal B are determined to participate in the current round of FRL. Therefore, the network side informs terminal A and terminal B of confirmation information. On receipt of the confirmation information, terminal A and terminal B train local learning models respectively based on a local dataset and the global model obtained in the first round, and upload the local learning models to the network side. The network side aggregates the received local learning models to obtain an updated global model, transmits the obtained complete updated global model to terminal A and terminal B participating in the FRL, and transmits a lightweight updated global model to terminal C that does not participate in the FRL. For example, the network side determines whether the updated global model converges. The process proceeds to the next round of FRL in a case where the updated global model does not converge, and otherwise the process ends.

In addition, the communication unit 102 may further provide the updated global model to the wireless communication terminals participating in the FRL. The wireless communication terminals that do not participate in the FRL acquire the updated global model from the wireless communication terminals participating in the FRL via P2P communication. An example of relevant information flow in this case is shown in FIG. 5. As can be seen, a difference between FIG. 5 and FIG. 4 lies in methods of updating a global model for the terminal that does not participate in FRL. For the sake of brevity, the description of the same part as in FIG. 4 is not repeated here. After the first round of FRL, the network side provides the complete updated global model to terminal A and terminal C participating in FRL, and terminal B that does not participate in FRL transmits a global model update request to terminal A via P2P communication. In response to the request, terminal A provides the updated global model obtained from the network side to terminal B. Here, the P2P communication may be implemented in multiple manners, including but not limited to WiFi, Bluetooth, RFID, and sidelink communication. Similarly, after the second round of FRL, terminal C that does not participate in FRL acquires the updated global model from terminal B via P2P communication.

The communication unit 102 may be further configured to instruct the wireless communication terminals participating in FRL to perform model distillation to control a data volume of the local learning models to a predetermined volume. In this case, the data volume of the to-be-uploaded local learning models is effectively reduced, and thereby a latency and a requirement for transmission resources are reduced. For example, the instruction may be sent together with the confirmation information shown in FIG. 4, or may be sent in a separate signaling, which are not restrictive.

The predetermined volume may be the same or different for different wireless communication terminals. For example, in a case that the data volume of the models after distillation is required to be the same (that is, the predetermined volume is the same), the predetermined volume may be set to a data volume of a model that can be transmitted by a wireless communication terminal with the worst wireless communication environment (such as channel quality).

In another aspect, in a case that the data volume of models after distillation is required to be different (that is, the predetermined volume is different), for example, a wireless communication terminal with a strong processing capability may be configured with a model with a large data volume, and a wireless communication terminal with a weak processing capability may be configured with a model with a small data volume. In this case, the wireless communication terminals with different processing capabilities can exchange their underlying training results via P2P communication during the training process of the local learning models, to ensure that models of different sizes can be aggregated on the network side. For example, the P2P communication includes but is not limited to Sidelink communication, WiFi, Bluetooth, and RFID.

For example, the communication unit 102 is further configured to schedule the wireless communication terminals participating in the FRL to upload the local learning models, so that an end time of model uploading of each wireless communication terminal is consistent. For example, the communication unit 102 may schedule the wireless communication terminals according to the data volume of the models configured to the wireless communication terminals.

In summary, with the electronic apparatus 100 according to this embodiment, the wireless communication terminals to participate in the FRL are selectively determined, so that the probability of congestion in data transmission is reduced and the transmission latency is reduced, while the performance of learning is ensured. In addition, in this embodiment, all wireless communication terminals within the coverage of the wireless transceiving node can keep the update of the global model, ensuring that the positive feedback for the global model can be provided while participating in the FRL, which is conducive to improving the convergence speed of the global model.

### Second Embodiment

As the wireless communication environment changes at any time, there may be a situation where a wireless communication terminal participating in FRL fails to upload a local learning model in time due to a sudden change of the wireless communication environment. In order to ensure a timely update of the global model, a solution in which another wireless communication terminal participating in the FRL assists in communication is provided in this embodiment.

The electronic apparatus 100 according to this embodiment includes the same functional modules as the electronic apparatus 100 in the first embodiment. For example, the communication unit 102 is further configured to schedule a first wireless communication terminal participating in the FRL to assist a second wireless communication terminal participating in the FRL in uploading of the local learning model. The second wireless communication terminal transmits a part or all of the local learning model to the first wireless communication terminal via P2P communication to be uploaded by the first wireless communication terminal. For example, the P2P communication includes, but is not limited to, Sidelink communication, WiFi, Bluetooth, and RFID. The “first” and “second” here are only for distinguishing one from another, and do not represent any order or priority.

For example, the wireless communication environment of the first wireless communication terminal is better than the wireless communication environment of the second wireless communication terminal. In this case, the determination unit 101 for example determines that the channel state for the first wireless communication terminal is suitable for transmitting a large model, and the channel state for the second wireless communication terminal is suitable for transmitting a small model or not suitable for uploading a model. Thus, the first wireless communication terminal may assist the second wireless communication terminal in uploading the model.

To facilitate understanding, FIG. 6 shows an example of relevant information flow of assisted module upload in FRL. In FIG. 6, the information flow of a single round of FRL is shown, where the network side determines that terminal A and terminal C are to participate in this round of FRL. In the example in FIG. 6, it is assumed that the wireless communication environment (such as channel state) of terminal A is better than the wireless communication environment of the terminal C. Therefore, the network side determines that terminal A assists terminal C in uploading the model. Therefore, the network side transmits scheduling information while transmitting confirmation information to terminal A and terminal C. For example, the scheduling information instructs terminal A to assist terminal C in uploading the local learning model. It should be noted that although the confirmation information and the scheduling information are shown in FIG. 6 as a single signaling, this is not restrictive and the confirmation information and the scheduling information may be transmitted separately. In addition, the timing of transmitting the scheduling information is not limited thereto. For example, the scheduling information may be transmitted during the training of the local learning model or during the uploading of the model. Moreover, the scheduling information may be transmitted in response to a request from terminal C, which is not restrictive.

The scheduling information includes for example one or more of identifications (ID) of terminal A and terminal C, a size of a to-be-uploaded model, an incentive strategy, and a P2P communication mode. For example, the incentive strategy is to provide extra rewards (such as additional model sharing) to encourage a terminal to assist other terminal in uploading a model. As mentioned above, the P2P communication here, for example, includes but is not limited to Sidelink communication, WiFi, Bluetooth, RFID and the like. In addition, scheduling information may have different contents for terminal A which provides assistance and terminal C which receives the assistance. For example, the scheduling information for terminal A indicates to provide assistance to terminal C, and the scheduling information for terminal C indicates that assistance is to be provided by terminal A.

Terminal A and terminal C perform training of local learning models respectively. After the training is completed, terminal C transmits (shares) all or part of the trained local learning model to terminal A via P2P communication based on scheduling information, and terminal A uploads the local learning model from terminal C and the local learning model of terminal A to the network side. Terminal A has a good channel state and therefore can achieve fast model upload, so that a latency is reduced. In a case that terminal C shares only a part of the local learning model, the remaining part of the local learning model is uploaded to the network side by terminal C itself.

In addition, in a case that the P2P communication is Sidelink communication, terminal C may establish a sidelink between terminal C and terminal A in response to the scheduling information. As shown by the dashed lines in FIG. 6, terminal C transmits a request of establishing the sidelink to terminal A through a sidelink terminal discovery process, and terminal A transmits a sidelink establishment confirmation to terminal C in response to the request. Thereby, a sidelink between terminal A and terminal C is established, and the part or all of the local learning model of terminal C is transmitted to terminal A via the sidelink.

In summary, the electronic apparatus 100 according to this embodiment schedules the wireless communication terminal participating in the FRL to assist in model upload based on the P2P communication, so that the latency caused by model upload is further reduced, the timely update of the global model is ensured, and the convergence speed of the global model is improved.

### Third Embodiment

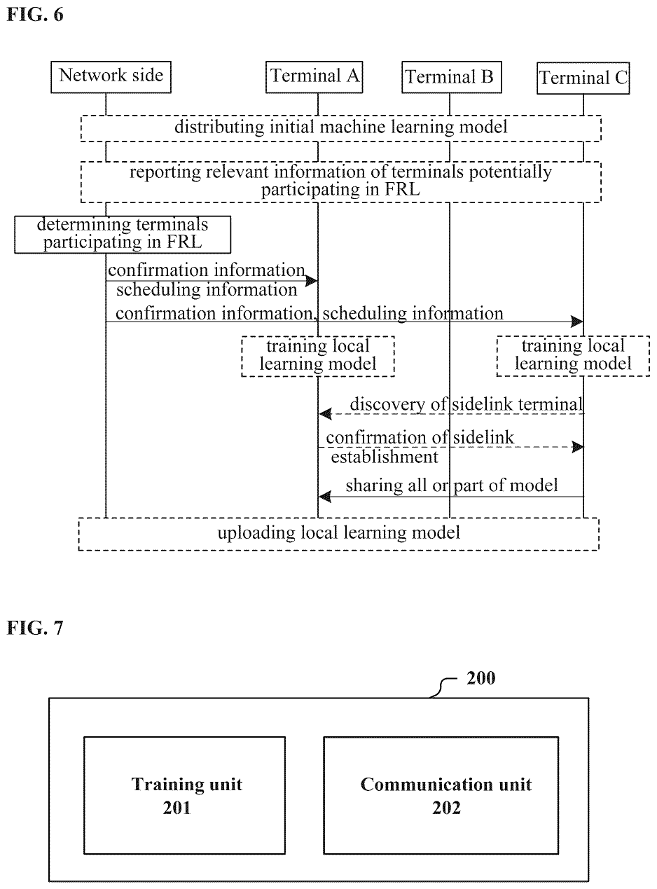

FIG. 7 is a block diagram showing functional modules of an electronic apparatus 200 for wireless communications according to another embodiment of the present disclosure. As shown in FIG. 7, the electronic apparatus 200 includes a training unit 201 and a communication unit 202. The training unit 201 is configured to perform training of a local learning model at a wireless communication terminal in response to confirmation information from a wireless transceiving node. The confirmation information indicates that the wireless transceiving node determines that the wireless communication terminal is to participate in FRL based on a processing capability and a wireless communication environment of the wireless communication terminal. The communication unit 202 is configured to upload the local learning model to the wireless transceiving node and acquire an updated global model from the wireless transceiving node.

The training unit 201 and the communication unit 202 may be implemented by one or more processing circuitries. The processing circuitry may be implemented as a chip or a processor, for example. Furthermore, it should be understood that the functional units in the electronic apparatus shown in FIG. 7 are only logical modules defined according to their specific functions, and are not intended to restrict a specific implementation.

The electronic apparatus 200 is, for example, arranged at a wireless communication terminal side or communicatively connected to a wireless communication terminal. The wireless communication terminals herein may be various user equipments (UEs) or user terminals capable of participating in the FRL, or may be mobile base stations or other communication terminals. The wireless transceiving node may be a base station, an access point (AP), a road side unit, or the like, and more generally, represents a network side or cloud server side.

The electronic apparatus 200 may be implemented at a chip level or at an apparatus level. For example, the electronic apparatus 200 may operate as a wireless communication terminal itself and may further include external apparatuses such as a memory, a transceiver (not shown) and the like. The memory may be configured to store programs to be executed by the wireless communication terminal for implementing various functions and related data information. The transceiver may include one or more communication interfaces to support communications with different apparatuses (such as other wireless communication terminals, base stations, core networks and the like). An implementation of the transceiver is not limited here.

Similar to the first embodiment, the wireless communication environment of the wireless communication terminal includes one or more of a wireless channel quality, a data rate, strength of interferences, a geographical location, an information transmission path loss related to the geographical location, and a movement speed.

In the scenario example of Internet of vehicles, the wireless communication terminal is a vehicle or a vehicle in the platoon, and the processing capability of the vehicle includes one or more of an automated driving level of the vehicle and an environment perception capability of the vehicle.

The communication unit 202 may be further configured to provide the wireless transceiving node with at least part of information on the processing capability and the wireless communication environment of the wireless communication terminal. The wireless transceiving node determines, based on this information and/or relevant information stored by itself, that the wireless communication terminal is to participate in the FRL and transmits confirmation information. The communication unit 202 is configured to receive the confirmation formation.

As a wireless communication terminal participating in the FRL, the communication unit 202 of the wireless communication terminal may acquire an updated global model from the wireless transceiving node. In an example, the communication unit 202 is further configured to provide the updated global model to a wireless communication terminal not participating in the FRL via P2P communication. For example, the communication unit 202 receives a global model update request sent by a wireless communication terminal that does not participate in the FRL via P2P communication, and provides the acquired updated global model to the wireless communication terminal via P2P communication in response to the request. Here, the P2P communication may be implemented in multiple manners, including but not limited to Wifi, Bluetooth, RFID, sidelink communication, and the like. An example of the detailed information flow is shown in FIG. 5 and is not repeated here.

In addition, for example, in a case that the wireless communication environment of the wireless communication terminal is poor, the communication unit 202 may further be configured to upload part or all of the local learning model with assistance of another wireless communication terminal participating in the FRL.

As an example, the communication unit 202 may receive scheduling information from the wireless transceiving node, and perform model transmission between the wireless communication terminal and another wireless communication terminal via P2P communication based on the scheduling information. The P2P communication may be implemented in multiple manners, including but not limited to WiFi, Bluetooth, RFID, sidelink communication, and the like. For example, the communication unit 202 may establish a sidelink between the wireless communication terminal and the another wireless communication terminal in response to the scheduling information. For example, the scheduling information includes one or more of identifications (ID) of the wireless communication terminal and the another wireless communication terminal, a size of a to-be-uploaded model, an incentive strategy, and a P2P communication mode. Relevant details are given in detail in the second embodiment with reference to FIG. 6, which are applied here in the same manner and is not described repeatedly.

As another example, the communication unit 202 may determine another wireless communication terminal capable of providing assistance by broadcasting a request information, and the wireless communication terminal performs P2P communication with the another wireless communication terminal. The request information includes for example one or more of an ID of the wireless communication terminal, a size of a to-be-uploaded model, and an incentive strategy. For example, on receipt of the confirmation information, the communication unit 202 starts to search for another wireless communication terminal in the vicinity that is willing and able to assist the communication unit 202 in uploading the model, so as to further reduce the latency. When such wireless communication terminal is found, after the training of the local learning model is completed, the communication unit 202 transmits part or all of the local learning model to the another wireless communication terminal via P2P communication.

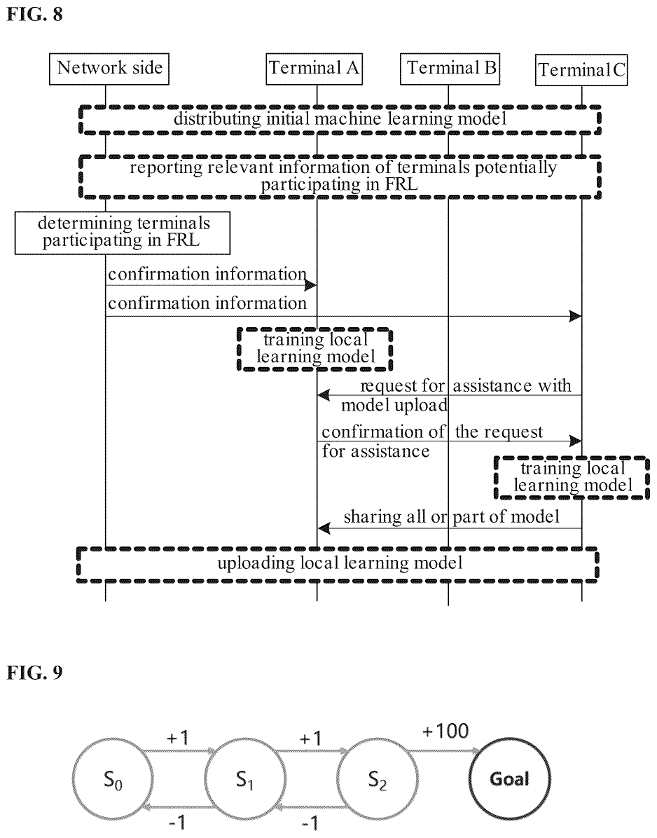

To facilitate understanding, FIG. 8 shows relevant information flow of assisted module upload in FRL according to the example. The information flow of a single round of FRL is shown in FIG. 8. The flow before determining terminals participating in the FRL is the same as the corresponding part of FIG. 6 and is not repeated here. In FIG. 8, the network side transmits confirmation information to terminal A and terminal C that are determined to participate in the FRL. It is assumed that terminal C that receives the confirmation information has a poor wireless communication environment, and therefore needs assistance with model upload via P2P communication. Therefore, terminal C broadcasts request information within its coverage for requesting assistance with model upload. The request information includes for example one or more of an identification (ID) of terminal C, a size of a to-be-uploaded model, and an incentive strategy. On receipt of the broadcasted request information, terminal A determines to provide assistance to terminal C and transmits to terminal C a confirmation of the request for assistance. Terminal C trains the local learning model. After the training is completed, terminal C transmits (shares) part or all of the local learning model to terminal A via P2P communication. Terminal A uploads the received local learning model of terminal C and a local learning model of terminal A to the network side. In a case that terminal C shares a part of the local learning model, the remaining part of the local learning model is uploaded to the network side by terminal C itself. Similarly, the P2P communication may be implemented in multiple manners, including but not limited to WiFi, Bluetooth, RFID, sidelink communication and the like.

The electronic apparatus 200 according to this embodiment performs assisted model upload via P2P communication by using another wireless communication terminal participating in the FRL, so that the latency caused by model uploading in a poor wireless communication environment is reduced, the timely update of the global model is ensured, and the convergence speed of the global model is improved.

In the scenario example of Internet of vehicles, the wireless communication terminal is a vehicle or a vehicle in a platoon. The training unit 201 is configured to define a predetermined reward function in training of the local learning model. The reward function includes, for example, one or more of a forward driving reward, a collision avoidance reward and a speed maintenance reward.

A main purpose of the reward function design is to determine effectiveness of a vehicle behavior according to the vehicle behavior and the vehicle's response to the current environment, thereby enable the vehicle to perform learning and iteration with respect to the behavior of the vehicle towards a goal. As shown in a schematic diagram in FIG. 9, S₀ to S₃ represent states, and a number above an arrow represents a reward value or a penalty value. A positive number represents a reward value and a negative number represents a penalty value.

For example, the forward driving reward is mainly for ensuring that the vehicle travels in a relatively correct direction, including that the vehicle faces a forward direction on the road and the vehicle does not exceed the lane lines on the left or right side. For example, the forward driving reward may be calculated by

$${R}_{Froward} = - ( {k}_{1} {e}_{1}^{2} + {k}_{2} {e}_{1}^{2} + {k}_{3} \vert {e}_{2} \vert + {k}_{1} \vert {e}_{2}^{′} \vert ) \qquad ( 1 )$$

wherein e₁ represents an offset distance of the vehicle, e₂ represents an offset angle of the vehicle, and e′ represents a change rate of the corresponding parameter. Here, k₁, k₂, k₃ and k₄ represents coefficients for the corresponding variables.

The collision avoidance reward is mainly for determining a safety distance from the vehicle to an obstacle, so as to avoid collision between the vehicle and the obstacle. Referring to the following equation (2), a dynamical safety distance (LoSD(v_{f}), LaSD(vₐᵥᵤₜ)) is calculated based on the Bereley algorithm. The dynamical safety distance is related to vehicle velocities v_{f} and vₐᵥᵤₜ, accelerations α_{f} and αₐᵥᵤₜ, a vehicle steering angle β, and a vehicle response time τ, wherein the subscript avut represents the current vehicle under test, and the subscript f represents a vehicle (or a leading vehicle) followed by the current vehicle. By calculating the safety distance and obtaining the location information via the server, a collision probability may be calculated. The greater the collision probability, the greater the penalty.

$$LoSD ( {v}_{f} ) = \frac{1}{2} \frac{{v}_{f}^{2}}{{α}_{f}} + {v}_{f} τ + {R}_{min} LaSD ( {v}_{avut} ) = \frac{{( {v}_{avut} \times sin β )}^{2}}{{α}_{avut} \times sin β} \qquad ( 2 )$$

wherein Rₘᵢₙ represents a minimum distance that the current vehicle needs to maintain when the vehicle followed by the current vehicle makes an emergency stop, and also represents a necessary tolerance for distance calculation error. When the speed is less than or equal to a speed limit, a reward is generated along the road direction for a certain distance traveled. A penalty is imposed when the speed exceeds the speed limit. The following equation (3) indicates that, after the vehicle has traveled an effective distance, the reward increases with an increase of the speed along the road direction, thereby encouraging the vehicle to accelerate. However, the penalty is imposed when the vehicle speed exceeds the speed limit. In this way, the vehicle is made to drive close to the speed limit. In the equation, Rvₖₑₑₚ represents a speed maintenance reward, ω represents a reward coefficient for each distance, vₜ*cos β represents a speed along the road direction, and vₘₐₓ represents a maximum speed on the road.

$${R}_{{V}_{keep}} = \{ \begin{matrix}ω * ( {V}_{t} * cos β ) , & {v}_{t} \leq {v}_{max} \\ - 1 , & {v}_{t} > {v}_{max}\end{matrix} \qquad ( 3 )$$

It should be understood that the above reward functions are illustrative, rather than restrictive.

In addition, in a case that the reward function is applied to a platooning scenario, the platoon is regarded as a whole when traveling. Therefore, not all vehicles in the platoon are required to participate in the FRL from the perspective of resource consumption, and the reward function is equally applied to the vehicles participating in the FRL and other member vehicles that only perform local learning. For example, the leading vehicle may participate in the FRL. Vehicles that do not participate in the FRL may acquire the latest global model from the leading vehicle to improve their perception and decision-making capabilities in an environment.

A platoon member that does not participate in the FRL may update its driving strategy in one of the following two manners. In the first manner, the platoon member does not actively learn the surrounding environment or update the driving strategy, but directly acquires a vehicle control instruction and a vehicle driving parameter from the leading vehicle. In the second manner, the platoon member actively learns the surrounding environment and updates the driving strategy. For example, the platoon member may acquire the updated global model from the leading vehicle and update the driving strategy of the vehicle based on a combination of the updated global model and its local learning result.

In addition, the platoon members participating in the FRL may transmits their local learning models to the leading vehicle, and the leading vehicle may perform a coarse update on the local model of the platoon based on the local learning models of the platoon members, and transmits the coarsely updated local model of the platoon to the network side. Accordingly, in a case that the wireless communication terminal corresponding to the electronic apparatus 200 is the leading vehicle in the platoon, the training unit 201 is further configured to perform the coarse update on the local model of the platoon based on the local learning models of the platoon members, and upload the coarsely updated local model of the platoon to the wireless transceiving node. In addition, the communication unit 202 is further configured to transmit the updated global model acquired from the wireless transceiving node to the platoon members.

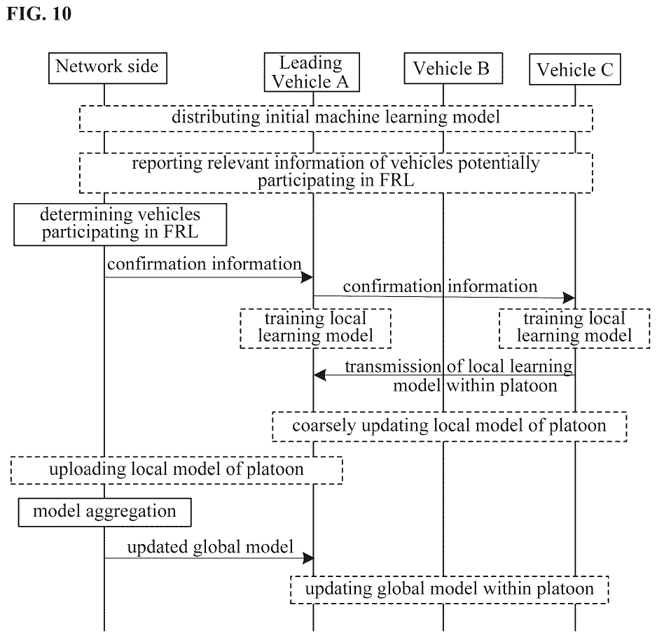

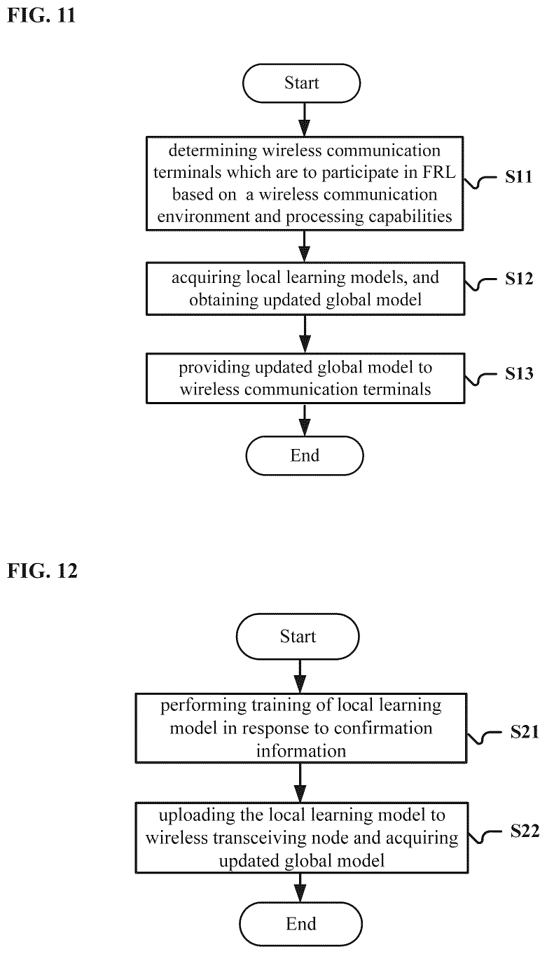

To facilitate understanding, FIG. 10 shows an example of relevant information flow of FRL in a platoon application scenario. The information flow before determining vehicles participating in the FRL is similar to the corresponding flow shown in FIG. 4 and is not repeated here. The network side determines that leading vehicle A and vehicle C are to participate in FRL. The network side transmits confirmation information for leading vehicle A and confirmation information for vehicle C both to leading vehicle A, and leading vehicle A forwards the confirmation information (such as an ID of the vehicle participating in the FRL) to vehicle C. Leading vehicle A and vehicle C perform training of local learning models based on local datasets. After the training is completed, vehicle C provides its local learning model to leading vehicle A via transmission within the platoon, and then leading vehicle A perform coarse update on a local model of the platoon based on the local learning models of leading vehicle A and vehicle C, and uploads the coarsely updated local model of the platoon to the network side. Vehicle C does not need to additionally upload the local learning model, so that resource consumption is reduced. The network side aggregates the uploaded local model of the platoon and the local learning models acquired from other vehicles to obtain an updated global model, and transmits the updated global model to leading vehicle A. Leading vehicle A distributes the updated global model in the platoon, so that update of the global model is synchronized for the platoon members.

### Fourth Embodiment

In the description of the electronic apparatus for wireless communications in the above embodiments, some processes or methods are further disclosed. Hereinafter, an overview of the methods is given without repeating some of details discussed above. It should be noted that although disclosed in the description of the electronic apparatus for wireless communications, the methods do not necessarily adopt the components as described or be performed by those components. For example, an embodiment of the electronic apparatus for wireless communications may be implemented partially or entirely using hardware and/or firmware, and a method for wireless communications discussed below may be implemented entirely by a computer-executable program, although the method may employ the hardware and/or firmware for the electronic apparatus for wireless communications.

FIG. 11 shows a flowchart of a method for wireless communications according to an embodiment of the present disclosure. The method includes: determining (S11), at least based on processing capabilities and a wireless communication environment of wireless communication terminals within a coverage range of a wireless transceiving node, wireless communication terminals which are to participate in FRL; and acquiring, from the wireless communication terminals participating in the FRL, respective local learning models, and obtaining an updated global model based on the local learning models (S12). For example, the method may be performed on the wireless transceiving node side.

For example, the wireless communication environment of the wireless communication terminal includes one or more of a wireless channel quality, a data rate, strength of interferences, a geographical location, an information transmission path loss related to the geographical location, and a movement speed. Information about the wireless communication environment and the processing capability may be acquired at least partially from the wireless communication terminals. For example, when determining the wireless communication terminal which is to participate in the FRL, the wireless communication environment of the wireless communication terminal may have a higher weight than the processing capability of the wireless communication terminal.

In addition, as shown by the dashed box in FIG. 11, the method further includes step S13: providing the updated global model to the wireless communication terminals within the coverage range. As an example, a complete updated global model may be provided to the wireless communication terminals participating in the FRL, and a lightweight updated global model may be provided to a wireless communication terminal that does not participate in the FRL. As another example, the updated global model may be provided to the wireless communication terminals participating in the FRL, and the wireless communication terminal that does not participate in the FRL may acquire the updated global model from a wireless communication terminal participating in the FRL via P2P communication.

In addition, although not shown in the figure, the method may further include: scheduling a first wireless communication terminal participating in the FRL to assist a second wireless communication terminal participating in the FRL in uploading of the local learning model. The second wireless communication terminal transmits a part or all of the local learning model to the first wireless communication terminal via P2P communication, to be uploaded by the first wireless communication terminal. For example, the wireless communication environment of the first wireless communication terminal is better than the wireless communication environment of the second wireless communication terminal. For example, the P2P communication includes sidelink communication.

The method may further include: instructing the wireless communication terminals participating in the FRL to perform model distillation to control a data volume of the local learning models to be a predetermined volume. The method may include scheduling the wireless communication terminals participating in the FRL to upload the local learning models, so that an end time of model uploading of each wireless communication terminal is consistent.

As an example, the wireless communication terminal may be a vehicle or a vehicle in a platoon. The processing capability of the vehicle includes one or more of an automated driving level of the vehicle and an environment perception capability of the vehicle. In the training of the local learning model by the vehicle, a predetermined reward function may be defined. The reward function for example includes one or more of a forward driving reward, a collision avoidance reward and a speed maintenance reward.

The method corresponds to the electronic apparatus 100 in the first and the second embodiments, and detailed descriptions are given in the first and the second embodiments and are not repeated here.

FIG. 12 shows a flowchart of a method for wireless communications according to another embodiment of the present disclosure. The method includes: in response to confirmation information from a wireless transceiving node, performing (S21) training of a local learning model at a wireless communication terminal, wherein the confirmation information indicates that the wireless transceiving node determines, based on a processing capability and a wireless communication environment of the wireless communication terminal, that the wireless communication terminal is to participate in FRL; and uploading (S22) the local learning model to the wireless transceiving node and acquiring an updated global model from the wireless transceiving node. The method may be implemented at the wireless communication terminal side for example.

Similarly, the wireless communication environment of the wireless communication terminal may include one or more of a wireless channel quality, a data rate, a strength of interferences, a geographical location, an information transmission path loss related to the geographical location, and a movement speed.

Although not shown in the figure, the method may further include: in response to a request from a wireless communication terminal which does not participate in the FRL, providing the updated global model to the wireless communication terminal which does not participate in the FRL via P2P communication.

The method further includes uploading a part or all of the local learning model of the wireless communication terminal with assistance of another wireless communication terminal participating in the FRL

In an example, the another wireless communication terminal may be determined by broadcasting request information, and the wireless communication terminal performs P2P communication with the another wireless communication terminal. For example, the request information includes one or more of an identification of the wireless communication terminal, a size of a to-be-uploaded model, and an incentive strategy.

In another example, model transmission may be performed between the wireless communication terminal and the another wireless communication terminal via P2P communication based on scheduling information from the wireless transceiving node.

For example, the wireless communication terminal may be a vehicle or a vehicle in a platoon. The processing capability of the vehicle includes one or more of an automated driving level of the vehicle and an environment perception capability of the vehicle.

The method further includes: defining a predetermined reward function in training of the local learning model by the vehicle. The reward function includes one or more of a forward driving reward, a collision avoidance reward and a speed maintenance reward.

In a case that the wireless communication terminal is a leading vehicle in the platoon, the method further includes: performing coarse update on a local learning model of the platoon by the leading vehicle based on local learning models of members of the platoon, and uploading the coarsely updated local learning model of the platoon to the wireless transceiving node. The leading vehicle may further transmit the updated global model acquired from the wireless transceiving node to the members of the platoon.

The method corresponds to the electronic apparatus 200 in the third embodiment. The relevant detailed description is given in the third embodiment and is not repeated here.

It should be noted that the above methods may be applied in combination or separately.

The technology of the present disclosure may be applied to various products.

For example, the electronic apparatus 100 may be implemented as various types of base stations. The base station may be implemented as any type of evolved node B (eNB) or gNB (5G base station). An eNB includes, for example, a macro eNB and a small eNB. A small eNB may be an eNB that covers a cell smaller than a macro cell, such as a pico eNB, a micro eNB, and a home (femto) eNB. The gNB may have similar situations as above. Alternatively, the base station may be implemented as any other type of base station, such as a NodeB or a base transceiver station (BTS). The base station may include a main body (that is also referred to as a base station device) configured to control wireless communications, and one or more remote radio heads (RRH) arranged in a different place from the main body. In addition, various types of user equipment may serve as base stations by temporarily or semi-permanently performing functions of the base station.

The electronic apparatus 200 may be implemented as various types of user equipment. The user equipment may be implemented as a mobile terminal (such as a smartphone, a tablet personal computer (PC), a notebook PC, a portable game terminal, a portable/dongle type mobile router, and a digital camera), or an in-vehicle terminal (such as a vehicle navigation apparatus). The user equipment may be implemented as a terminal (which is also referred to as a machine type communication (MTC) terminal) that performs machine-to-machine (M2M) communications. Furthermore, the user equipment may be a wireless communication module (such as an integrated circuitry module including a single chip) mounted on each of the terminals.

### [Application Example of Base Station]

### First Application Example

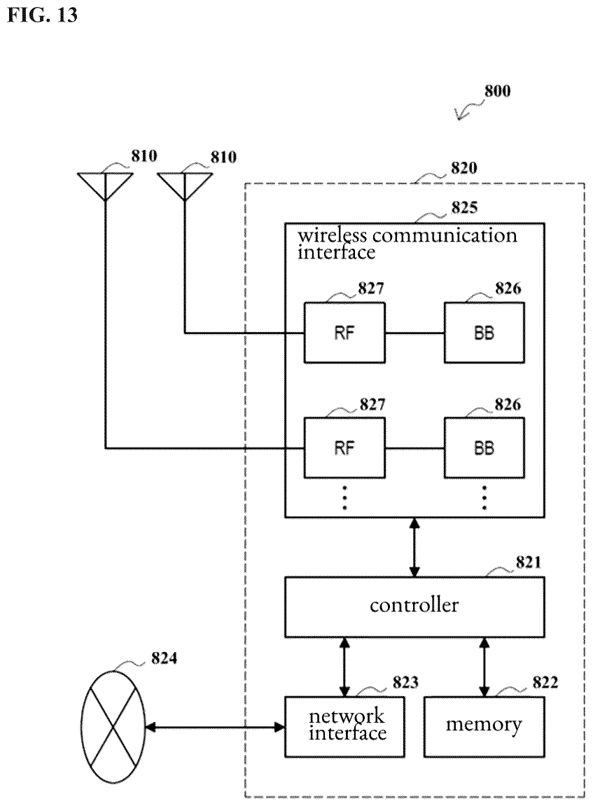

FIG. 13 is a block diagram showing a first example of a schematic configuration of an eNB or gNB to which the technology of the present disclosure may be applied. It should be noted that the following description is made taking the eNB as an example. The technology of the present disclosure is also applicable to the gNB. An eNB 800 includes one or more antennas 810 and a base station apparatus 820. The base station apparatus 820 and each of the antennas 810 may be connected to each other via a RF cable.

Each of the antennas 810 includes a single or multiple antenna elements (such as multiple antenna elements included in a Multiple Input Multiple Output (MIMO) antenna), and is used by the base station apparatus 820 to transmit and receive radio signals. As shown in FIG. 13, the eNB 800 may include multiple antennas 810. For example, the multiple antennas 810 may be compatible with multiple frequency bands used by the eNB 800. Although FIG. 13 illustrates the example in which the eNB 800 includes the multiple antennas 810, the eNB 800 may include a single antenna 810.

The base station apparatus 820 includes a controller 821, a memory 822, a network interface 823, and a wireless communication interface 825.

The controller 821 may be, for example, a CPU or DSP, and operates functions of a higher layer of the base station apparatus 820. For example, the controller 821 generates a data packet from data in signals processed by the wireless communication interface 825, and transfers the generated packet via the network interface 823. The controller 821 may bundle data from multiple base band processors to generate a bundled packet, and transfer the generated bundled packet. The controller 821 may have logical functions of performing for example radio resource control, radio bearer control, mobility management, admission control, and scheduling. The control may be performed in connection with a core network node or an eNB in the vicinity. The memory 822 includes an RAM and an ROM, and stores a program executed by the controller 821 and various types of control data (such as a terminal list, transmission power data, and scheduling data).

The network interface 823 is a communication interface for connecting the base station apparatus 820 to a core network 824. The controller 821 may communicate with a core network node or another eNB via the network interface 823. In this case, the eNB 800, and the core network node or the other eNB may be connected to each other via a logical interface (such as SI interface and X2 interface). The network interface 823 may be a wired communication interface or a wireless communication interface for a wireless backhaul link. If the network interface 823 is a wireless communication interface, the network interface 823 may use a higher frequency band for wireless communications than a frequency band used by the wireless communication interface 825.

The wireless communication interface 825 supports any cellular communication scheme (such as Long Term Evolution (LTE) and LTE-advanced), and provides wireless connection to a terminal located in a cell of the eNB 800 via the antenna 810. The wireless communication interface 825 may generally include, for example, a baseband (BB) processor 826 and an RF circuitry 827. The BB processor 826 may perform, for example, encoding/decoding, modulating/demodulating, and multiplexing/demultiplexing, and performs various types of signal processing of layers (such as L1, media access control (MAC), radio link control (RLC), and a packet data convergence protocol (PDCP)). The BB processor 826 may have a part or all of the above-described logical functions instead of the controller 821. The BB processor 826 may be a memory storing communication control programs, or a module including a processor and a related circuitry configured to execute the programs. Updating the program may cause the functions of the BB processor 826 to be changed. The module may be a card or a blade that is inserted into a slot of the base station apparatus 820. Alternatively, the module may be a chip mounted on the card or the blade. Meanwhile, the RF circuitry 827 may include, for example, a mixer, a filter, and an amplifier, and transmits and receives radio signals via the antenna 810.

As shown in FIG. 13, the wireless communication interface 825 may include multiple BB processors 826. For example, the multiple BB processors 826 may be compatible with multiple frequency bands used by the eNB 800. As shown in FIG. 13, the wireless communication interface 825 may include multiple RF circuitries 827. For example, the multiple RF circuitries 827 may be compatible with multiple antenna elements. Although FIG. 13 illustrates the example in which the wireless communication interface 825 includes the multiple BB processors 826 and the multiple RF circuitries 827, the wireless communication interface 825 may include a single BB processor 826 or a single RF circuitry 827.

In the eNB 800 shown in FIG. 13, the communication unit 102 and the transceiver of the electronic apparatus 100 may be implemented by the wireless communication interface 825. At least a part of functions may be implemented by the controller 821. For example, the controller 821 may determine a suitable wireless communication terminal to participate in the FRL by performing the functions of the determination unit 101, the communication unit 102 and the acquisition unit 103, so that the latency of updating the global model is effectively reduced and the convergence speed of the global model is improved.

### Second Application Example

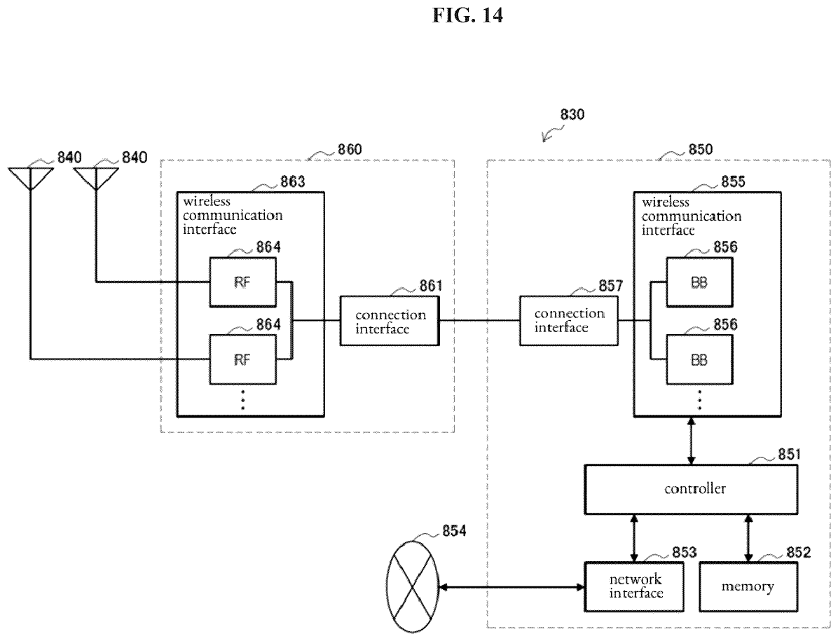

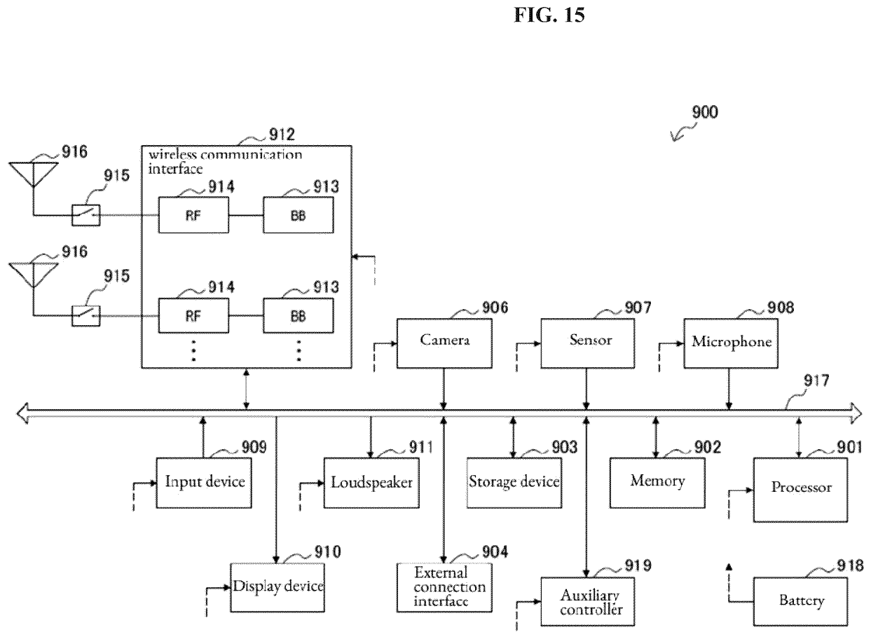

FIG. 14 is a block diagram showing a second example of a schematic configuration of an eNB or gNB to which the technology of the present disclosure may be applied. It should be noted that the following description is made taking the eNB as an example. The technology of the present disclosure is also applicable to the gNB. An eNB 830 includes a single or multiple antennas 840, base station apparatus 850 and an RRH 860. The RRH 860 is connected to each antenna 840 via an RF cable. The base station apparatus 850 and the RRH 860 may be connected to each other via a high-speed line such as an optical fiber cable.

Each of the antennas 840 includes a single or multiple antenna elements (such as multiple antenna elements included in an MIMO antenna), and is used by the RRH 860 to transmit and receive radio signals. As shown in FIG. 14, the eNB 830 may include multiple antennas 840. For example, the multiple antennas 840 may be compatible with multiple frequency bands used by the eNB 830. Although FIG. 14 illustrates the example in which the eNB 830 includes the multiple antennas 840, the eNB 830 may include a single antenna 840.

The base station apparatus 850 includes a controller 851, a memory 852, a network interface 853, a wireless communication interface 855, and a connection interface 857. The controller 851, the memory 852, and the network interface 853 are the same as the controller 821, the memory 822, and the network interface 823 described with reference to FIG. 13.

The wireless communication interface 855 supports any cellular communication scheme (such as LTE and LTE-Advanced), and provides radio communication to a terminal located in a sector corresponding to the RRH 860 via the RRH 860 and the antenna 840. The wireless communication interface 855 may generally include, for example, a BB processor 856. The BB processor 856 is the same as the BB processor 826 described with reference to FIG. 13, except the BB processor 856 is connected to the RF circuitry 864 of the RRH 860 via the connection interface 857. As shown in FIG. 14, the wireless communication interface 855 may include multiple BB processors 856. For example, the multiple BB processors 856 may be compatible with multiple frequency bands used by the eNB 830. Although FIG. 14 shows the example in which the wireless communication interface 855 includes multiple BB processors 856, the wireless communication interface 855 may include a single BB processor 856.

The connection interface 857 is an interface for connecting the base station apparatus 850 (wireless communication interface 855) to the RRH 860. The connection interface 857 may further be a communication module for communication in the above-described high-speed line that connects the base station apparatus 850 (the wireless communication interface 855) to the RRH 860.

The RRH 860 includes a connection interface 861 and a wireless communication interface 863.

The connection interface 861 is an interface for connecting the RRH 860 (wireless communication interface 863) to the base station apparatus 850. The connection interface 861 may further be a communication module for communication in the above-described high-speed line.

The wireless communication interface 863 transmits and receives radio signals via the antenna 840. The wireless communication interface 863 may generally include, for example, the RF circuitry 864. The RF circuitry 864 may include, for example, a mixer, a filter, and an amplifier, and transmits and receives radio signals via the antenna 840. As shown in FIG. 14, the wireless communication interface 863 may include multiple RF circuitries 864. For example, the multiple RF circuitries 864 may support multiple antenna elements. Although FIG. 14 illustrates the example in which the wireless communication interface 863 includes the multiple RF circuitries 864, the wireless communication interface 863 may include a single RF circuitry 864.

In the eNB 830 shown in FIG. 14, the communication unit 102 and the transceiver of the electronic apparatus 100 may be implemented by the wireless communication interface 855 and/or the wireless communication interface 863. At least part of the functions may be implemented by the controller 851. For example, the controller 851 may determine a suitable wireless communication terminal to participate in FRL by performing the functions of the determination unit 101, the communication unit 102 and the acquisition unit 103, so that a latency of updating the global model is reduced and a convergence speed of the global model is improved.

### [Application Example of User Equipment]

### First Application Example

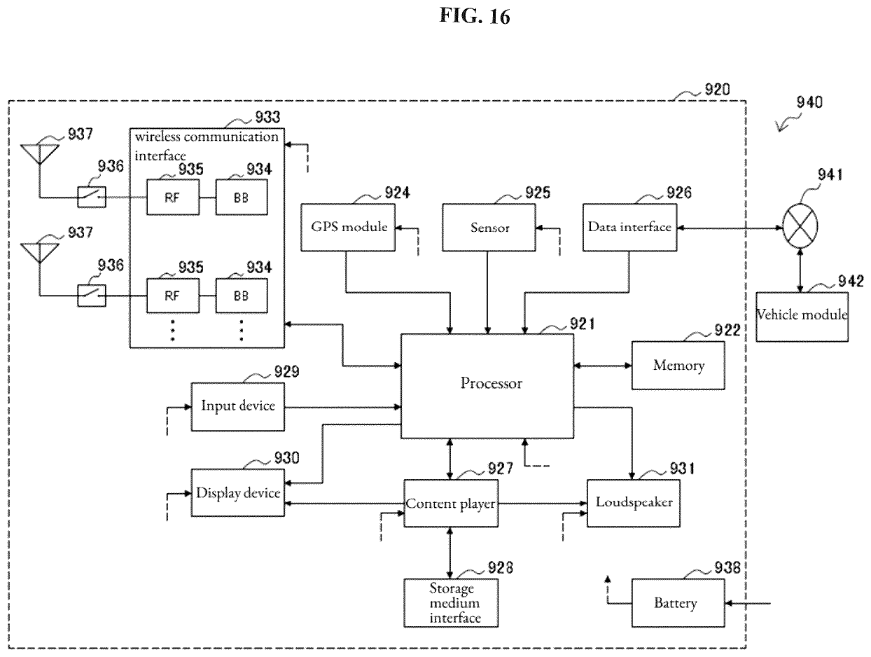

FIG. 15 is a block diagram showing an example of a schematic configuration of a smartphone to which the technology of the present disclosure may be applied. The smartphone 900 includes a processor 901, a memory 902, a storage 903, an external connection interface 904, a camera 906, a sensor 907, a microphone 908, an input device 909, a display device 910, a speaker 911, a wireless communication interface 912, one or more antenna switches 915, one or more antennas 916, a bus 917, a battery 918 and an auxiliary controller 919.

The processor 901 may be, for example, a CPU or a system on chip (SoC), and controls functions of an application layer and another layer of the smartphone 900. The memory 902 includes an RAM and an ROM, and stores programs executed by the processor 901 and data. The storage device 903 may include a storage medium, such as a semiconductor memory and a hard disk. The external connection interface 904 is an interface configured to connect an external apparatus (such as a memory card and a universal serial bus (USB) device) to the smartphone 900.

The camera 906 includes an image sensor (such as a charge coupled device (CCD) and a complementary metal oxide semiconductor (CMOS)) and generates a captured image. The sensor 907 may include a set of sensors, such as a measurement sensor, a gyroscope sensor, a geomagnetic sensor and an acceleration sensor. The microphone 908 converts sound inputted to the smartphone 900 into an audio signal. The input device 909 includes, for example, a touch sensor configured to detect touch on a screen of the display device 910, a keypad, a keyboard, a button, or a switch, and receives operations or information input from a user. The display device 910 includes a screen (such as a liquid crystal display (LCD) and an organic light-emitting diode (OLED) display), and displays an output image of the smartphone 900. The loudspeaker 911 converts the audio signal outputted from the smartphone 900 into sound.

The wireless communication interface 912 supports any cellular communication scheme (such as LTE and LTE-advanced), and performs wireless communication. The wireless communication interface 912 may generally include for example a BB processor 913 and an RF circuitry 914. The BB processor 913 may perform encoding/decoding, modulating/demodulating and multiplexing/de-multiplexing for example, and perform various types of signal processing for wireless communication. Meanwhile, the RF circuitry 914 may include, for example, a mixer, a filter and an amplifier, and transmits and receives a wireless signal via an antenna 916. It should be noted that, although the figure shows a situation where one RF link is connected to one antenna, this is only illustrative and a situation where one RF link is connected to multiple antennas through multiple phase shifters is possible. The wireless communication interface 912 may be a chip module on which the BB processor 913 and the RF circuitry 914 are integrated. As shown in FIG. 15, the wireless communication interface 912 may include multiple BB processors 913 and multiple RF circuitries 914. Although FIG. 15 illustrates the example in which the wireless communication interface 912 includes the multiple BB processors 913 and the multiple RF circuitries 914, the wireless communication interface 912 may include a single BB processor 913 or a single RF circuitry 914.

Furthermore, in addition to a cellular communication scheme, the wireless communication interface 912 may support another type of wireless communication scheme such as a short-distance wireless communication scheme, a near field communication scheme, and a wireless local area network (LAN) scheme. In that case, the wireless communication interface 912 may include a BB processor 913 and an RF circuitry 914 for each wireless communication scheme.

Each of the antenna switches 915 switches connection destinations of the antennas 916 among multiple circuitries (such as circuitries for different wireless communication schemes) included in the wireless communication interface 912.

Each of the antennas 916 includes a single or multiple antenna elements (such as multiple antenna elements included in an MIMO antenna), and is used by the wireless communication interface 912 to transmit and receive wireless signals. The smartphone 900 may include the multiple antennas 916, as shown in FIG. 15. Although FIG. 15 illustrates the example in which the smartphone 900 includes the multiple antennas 916, the smartphone 900 may include a single antenna 916.

Furthermore, the smartphone 900 may include the antenna 916 for each wireless communication scheme. In this case, the antenna switches 915 may be omitted from the configuration of the smartphone 900.

The bus 917 connects the processor 901, the memory 902, the storage device 903, the external connection interface 904, the camera 906, the sensor 907, the microphone 908, the input device 909, the display device 910, the loudspeaker 911, the wireless communication interface 912 and the auxiliary controller 919 with each other. The battery 918 supplies power for blocks in the smartphone 900 shown in FIG. 15 via feeder lines which are indicated partially as dashed lines in the figure. The auxiliary controller 919 operates a minimum necessary function of the smartphone 900 in a sleeping mode, for example.

In the smartphone 900 shown in FIG. 15, the communication unit 202 and the transceiver of the electronic apparatus 200 may be implemented by the wireless communication interface 912. At least a part of functions may be implemented by the processor 901 or the auxiliary controller 919. For example, the processor 901 or the auxiliary controller 919 may implement the training of the local learning model and timely update of the global model by performing functions of the training unit 201 and the communication unit 202.

### Second Application Example

FIG. 16 is a block diagram showing an example of a schematic configuration of a vehicle navigation apparatus 920 to which the technology according to the present disclosure may be applied. The vehicle navigation apparatus 920 includes a processor 921, a memory 922, a global positioning system (GPS) module 924, a sensor 925, a data interface 926, a content player 927, a storage medium interface 928, an input device 929, a display device 930, a speaker 931, a wireless communication interface 933, one or more antenna switches 936, one or more antennas 937 and a battery 938.

The processor 921 may be for example a CPU or SoC, and controls the navigation function and additional functions of the vehicle navigation apparatus 920. The memory 922 includes RAM and ROM, and stores a program executed by the processor 921 and data.

The GPS module 924 measures a position (such as latitude, longitude, and altitude) of the vehicle navigation apparatus 920 based on a GPS signal received from a GPS satellite. The sensor 925 may include a group of sensors, such as a gyroscope sensor, a geomagnetic sensor, and an air pressure sensor. The data interface 926 is connected to, for example, an in-vehicle network 941 via a terminal that is not shown, and acquires data (such as vehicle speed data) generated by the vehicle.

The content player 927 reproduces content stored in a storage medium (such as a CD and a DVD) that is inserted into the storage medium interface 928. The input device 929 includes for example a touch sensor configured to detect touch on a screen of the display device 930, a button or a switch, and receives an operation or information inputted from a user. The display device 930 includes a screen of an LCD or OLED display for example, and displays an image with a navigation function or the reproduced content. The loudspeaker 931 outputs a sound with a navigation function or the reproduced content.

The wireless communication interface 933 supports any cellular communication scheme (such as LTE and LTE-Advanced), and performs wireless communication. The wireless communication interface 933 may usually include, for example, a BB processor 934 and an RF circuitry 935. The BB processor 934 may perform, for example, encoding/decoding, modulating/demodulating, and multiplexing/demultiplexing, and performs various types of signal processing for wireless communication. Meanwhile, the RF circuitry 935 may include for example a mixer, a filter and an amplifier, and transmit and receive a wireless signal via the antenna 937. The wireless communication interface 933 may be a chip module on which the BB processor 934 and the RF circuitry 935 are integrated. As shown in FIG. 16, the wireless communication interface 933 may include multiple BB processors 934 and multiple RF circuitries 935. Although FIG. 16 shows an example in which the wireless communication interface 933 includes multiple BB processors 934 and multiple RF circuitries 935, the wireless communication interface 933 may include a single BB processor 934 or a single RF circuitry 935.

Furthermore, in addition to a cellular communication scheme, the wireless communication interface 933 may support another type of wireless communication scheme, such as a short-distance wireless communication scheme, a near field communication scheme and a wireless LAN scheme. In this case, for each of the wireless communication schemes, the wireless communication interface 933 may include a BB processor 934 and an RF circuitry 935.

Each of the antenna switches 936 switches connection destinations of the antennas 937 among multiple circuitries (such as circuitries for different wireless communication schemes) included in the wireless communication interface 933.

Each of the antennas 937 includes one or more antenna elements (such as multiple antenna elements included in a MIMO antenna) and is used by the wireless communication interface 933 to transmit and receive wireless signals. As shown in FIG. 16, the vehicle navigation apparatus 920 may include multiple antennas 937. Although FIG. 16 illustrates the example in which the vehicle navigation apparatus 920 includes the multiple antennas 937, the vehicle navigation apparatus 920 may include a single antenna 937.

Furthermore, the vehicle navigation apparatus 920 may include the antenna 937 for each wireless communication scheme. In that case, the antenna switches 936 may be omitted from the configuration of the vehicle navigation apparatus 920.

The battery 938 supplies power to each block of the vehicle navigation apparatus 920 shown in FIG. 16 via feeder lines which are partially shown with dashed lines in the drawing. The battery 938 accumulates power supplied from the vehicle.

In the vehicle navigation apparatus 920 shown in FIG. 16, the communication unit 202 and the transceiver of the electronic apparatus 200 may be implemented by the wireless communication interface 933. At least part of the functions may also be implemented by the processor 921. For example, the processor 921 may implement the training of the local learning model and timely update of the global model by performing functions of the training unit 201 and the communication unit 202.

The technology of the present disclosure may be implemented as an in-vehicle system (or a vehicle) 940 including the vehicle navigation apparatus 920, the in-vehicle network 941 and one or more blocks of and a vehicle module 942. The vehicle module 942 generates vehicle data (such as a vehicle speed, an engine speed and fault information), and outputs the generated data to the in-vehicle network 941.

The basic principle of the present disclosure has been described above in conjunction with specific embodiments. However, it should be noted that for those skilled in the art, all or any of the steps or components of the method and apparatus according to the disclosure can be implemented in a form of hardware, firmware, software or a combination thereof in any computing device (including a processor, a storage medium and the like) or a network of computing devices. Such implementation can be realized by those skilled after reading the description of the present disclosure, by utilizing general knowledge in circuitry design or general programming skills.

Moreover, a program product in which machine-readable instruction codes are stored is further provided according to the present disclosure. The instruction codes, when read and executed by the machine, perform the aforementioned methods according to the embodiments of the present disclosure.

Accordingly, a storage medium for carrying the program product storing the machine-readable instruction codes is further provided according to the present disclosure. The storage medium includes, but is not limited to, a floppy disk, an optical disk, a magneto-optical disk, a storage card, a memory stick, and the like.

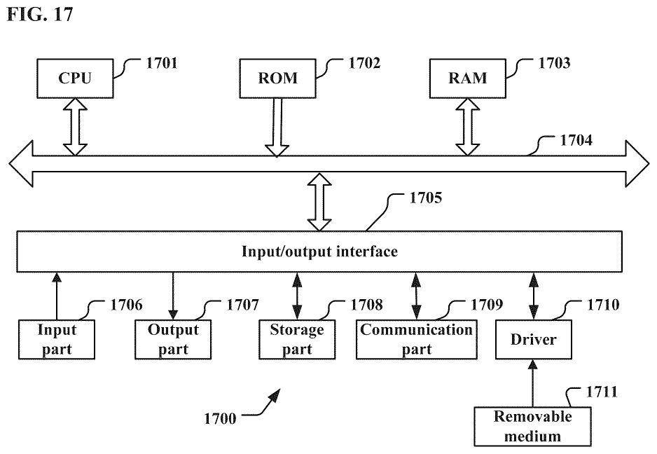

In a case that the present disclosure is implemented with software or firmware, a program constituting the software is installed in a computer with a dedicated hardware structure (such as the universal computer 1700 shown in FIG. 17) from a storage medium or network. The computer is capable of implementing various functions when installed with various programs.

In FIG. 17, a central processing unit (CPU) 1701 executes various processing according to a program stored in a read-only memory (ROM) 1702 or a program loaded from a storage part 1708 to a random-access memory (RAM) 1703. In the RAM 1703, data required for performing various processing by the CPU 1701 is also stored as required. The CPU 1701, the ROM 1702 and the RAM 1703 are connected with each other via a bus 1704. An input/output interface 1705 is connected to the bus 1704.

The following components are connected to the input/output interface 1705: an input part 1706 (including a keyboard, a mouse and the like), an output part 1707 (including displays such as cathode ray tube (CRT) and liquid crystal display (LCD), a loudspeaker and the like), a memory part 1708 (including hard disc and the like), and a communication part 1709 (including a network interface card such as LAN card, a modem and the like). The communication part 1709 performs communications via a network such as the Internet. A driver 1710 may also be connected to the input/output interface 1705 as required. A removable medium 1711, such as magnetic disk, optical disk, magnetic optical disk and semiconductor memory and the like, may be mounted to the driver 1710 as required, so that the computer program read therefrom is mounted to the storage part 1708 as required.

In the case of implementing the above processing in software, the program constituting the software is mounted from a network, such as the Internet, or from a storage medium, such as the removable medium 1711.

It is to be understood by those skilled in the art that, this storage medium is not limited to the removable medium 1711, as shown in FIG. 17, which stores the program and is distributed separately from the apparatus to provide the program for the user. Examples of the removable medium 1711 include a magnetic disk (including soft disk (registered trademark)), optical disk (including compact disk read-only memory (CD-ROM) and digital video disk (DVD)), magnetic optical disk (including mini disk (MD) (registered trademark)), and semiconductor memory. Alternatively, the storage medium may be the ROM 1702, the hard disk included in the storage part 1708 or the like. The storage medium stores a program and is distributed to the user along with an apparatus in which the storage medium is incorporated.

It should be further noted that, in the apparatus, method and system according to the present disclosure, the components or steps may be decomposed and/or recombined. These decompositions and/or re-combinations shall be regarded as equivalent solutions of the disclosure. Furthermore, the above series of processing steps may naturally be performed temporally in the sequence as described above but are limited thereto. Some steps may be performed in parallel with or independently from each other.

At last, it should be noted that terms “include”, “comprise” or any variants thereof are intended to be non-exclusive. Therefore, a process, method, article or apparatus including a series of elements includes not only the elements but also other elements that are not enumerated, or further includes the elements inherent to the process, method, article or apparatus. Unless expressively limited otherwise, the element defined by the statement “including a . . . ” does not exclude existence of other same elements in the process, method, article or apparatus.

Although the embodiments of the present disclosure are described in detail above with reference to the accompanying drawings, it should be understood that the implementations described above are only for explaining the present disclosure and do not limit the present disclosure. Those skilled in the art can make various modifications and changes to the above implementations without departing from the essence and scope of the present disclosure. Therefore, the scope of the present disclosure is defined only by the appended claims and equivalents thereof.

1. An electronic apparatus for wireless communications, comprising:
at least one processor; and
at least one memory including computer program code, where the at least one memory and the computer program code are configured, with the at least one processor, to cause the electronic apparatus to at least:
determine, at least based on a wireless communication environment and processing capabilities of wireless communication terminals within a coverage range of a wireless transceiving node, wireless communication terminals which are to participate in Federated Reinforcement Learning (FRL); and
acquire, from the wireless communication terminals participating in the FRL, respective local learning models, and obtain an updated global model based on the local learning models.

2. The electronic apparatus according to claim 1, wherein the wireless communication environment of the wireless communication terminals comprises one or more of a wireless channel quality, a data rate, a strength of interferences, a geographical location, an information transmission path loss related to the geographical location, and a movement speed.

3. The electronic apparatus according to claim 1, wherein the at least one memory and the computer program code are configured, with the at least one processor, to cause the electronic apparatus further to provide the updated global model to the wireless communication terminals within the coverage range.

4. The electronic apparatus according to claim 3, wherein the at least one memory and the computer program code are configured, with the at least one processor, to cause the electronic apparatus further to provide a complete updated global model to the wireless communication terminals participating in the FRL, and to provide a lightweight updated global model to a wireless communication terminal which does not participate in the FRL.

5. The electronic apparatus according to claim 3, wherein the at least one memory and the computer program code are configured, with the at least one processor, to cause the electronic apparatus further to provide the updated global model to the wireless communication terminals participating in the FRL, and wherein the wireless communication terminal which does not participate in the FRL acquires the updated global model from a wireless communication terminal participating in the FRL via P2P communication.

6. The electronic apparatus according to claim 1, wherein the at least one memory and the computer program code are configured, with the at least one processor, to cause the electronic apparatus further to at least partially acquire information on the wireless communication environment and the processing capabilities from the wireless communication terminals.

7. The electronic apparatus according to claim 1, wherein the at least one memory and the computer program code are configured, with the at least one processor, to cause the electronic apparatus further to schedule a first wireless communication terminal participating in the FRL to assist a second wireless communication terminal participating in the FRL in uploading of the local learning model, wherein the second wireless communication terminal transmits a part or all of the local learning model to the first wireless communication terminal via P2P communication to be uploaded by the first wireless communication terminal, and
wherein the P2P communication comprises sidelink communication.

8. (canceled)

9. The electronic apparatus according to claim 1, wherein the at least one memory and the computer program code are configured, with the at least one processor, to cause the electronic apparatus further to schedule the wireless communication terminals participating in the FRL to upload the local learning models, so that an end time of model uploading of each wireless communication terminal is consistent.

10. The electronic apparatus according to claim 1, wherein the at least one memory and the computer program code are configured, with the at least one processor, to cause the electronic apparatus further to instruct the wireless communication terminals participating in the FRL to perform model distillation to control a data volume of the local learning model to a predetermined volume.

11. The electronic apparatus according to claim 1, wherein in determining the wireless communication terminals which are to participate in FRL, the wireless communication environment of the wireless communication terminals has a higher weight than the processing capabilities of the wireless communication terminals.

12. The electronic apparatus according to claim 1, wherein the wireless communication terminals are vehicles or vehicles in a platoon,
wherein a processing capability of a vehicle comprises one or more of an automated driving level of the vehicle and an environment perception capability of the vehicle, and
wherein a predetermined reward function is defined in training of a local learning model by the vehicle, and the reward function comprises one or more of a forward driving reward, a collision avoidance reward and a speed maintenance reward.

13.-14. (canceled)

15. An electronic apparatus for wireless communications, comprising:
at least one processor; and
at least one memory including computer program code, where the at least one memory and the computer program code are configured, with the at least one processor, to cause the electronic apparatus to at least:
in response to confirmation information from a wireless transceiving node, perform training of a local learning model at a wireless communication terminal, wherein the confirmation information indicates that the wireless transceiving node determines, based on a wireless communication environment and a processing capability of the wireless communication terminal, that the wireless communication terminal is to participate in Federated Reinforcement Learning (FRL); and
upload the local learning model to the wireless transceiving node and acquire an updated global model from the wireless transceiving node.

16. The electronic apparatus according to claim 15, wherein the at least one memory and the computer program code are configured, with the at least one processor, to cause the electronic apparatus further to: in response to a request from a wireless communication terminal which does not participate in the FRL, provide the updated global model to the wireless communication terminal which does not participate in the FRL via P2P communication.

17. The electronic apparatus according to claim 15, wherein the at least one memory and the computer program code are configured, with the at least one processor, to cause the electronic apparatus further to upload a part or all of the local learning model of the wireless communication terminal with assistance of another wireless communication terminal participating in the FRL.

18. The electronic apparatus according to claim 17, wherein the at least one memory and the computer program code are configured, with the at least one processor, to cause the electronic apparatus further to determine the another wireless communication terminal by broadcasting request information, and the wireless communication terminal performs P2P communication with the another wireless communication terminal, and
wherein the request information comprises one or more of an identification of the wireless communication terminal, a size of a to-be-uploaded model, and an incentive strategy.

19. (canceled)

20. The electronic apparatus according to claim 17, wherein the at least one memory and the computer program code are configured, with the at least one processor, to cause the electronic apparatus further to perform model transmission between the wireless communication terminal and the another wireless communication terminal via P2P communication based on scheduling information from the wireless transceiving node.

21. The electronic apparatus according to claim 15, wherein the wireless communication environment of the wireless communication terminal comprises one or more of a wireless channel quality, a data rate, a strength of interferences, a geographical location, an information transmission path loss related to the geographical location, and a movement speed.

22. The electronic apparatus according to claim 15, wherein the wireless communication terminal is a vehicle or a vehicle in a platoon,
wherein a processing capability of the vehicle comprises one or more of an automated driving level of the vehicle and an environment perception capability of the vehicle, and
wherein the at least one memory and the computer program code are configured, with the at least one processor, to cause the electronic apparatus further to define a predetermined reward function in training of the local learning model, and the reward function comprises one or more of a forward driving reward, a collision avoidance reward and a speed maintenance reward.

23.-24. (canceled)

25. The electronic apparatus according to claim 22, wherein in a case that the wireless communication terminal is a leading vehicle in the platoon, the at least one memory and the computer program code are configured, with the at least one processor, to cause the electronic apparatus further to perform a coarse update of a local learning model of the platoon based on local learning models of members of the platoon, and upload the coarsely updated local learning model of the platoon to the wireless transceiving node.

26. The electronic apparatus according to claim 25, wherein the at least one memory and the computer program code are configured, with the at least one processor, to cause the electronic apparatus further to transmit the updated global model acquired from the wireless transceiving node to the members of the platoon.

27.-29. (canceled)
